(19) United States
(12) Patent Application Publication
(10) Pub. No.: US 2025/0068450 A1
(43) Pub. Date: Feb. 27, 2025

(54) HYPERVISOR SCHEDULING OF WORKLOADS ON HETEROGENEOUS PROCESSING CORES BASED ON WORKLOAD HINTS

(71) Applicant: VMware LLC, Palo Alto, CA (US)

(72) Inventors: Daniel James Beveridge, Valrico, FL (US); Corey Douglas Lyons, Maumee, OH (US)

(21) Appl. No.: 18/456,161

(22) Filed: Aug. 25, 2023

(51) Int. Cl. G06F 9/455; G06F 9/48

(52) U.S. Cl. CPC G06F 9/45558; G06F 9/4881; G06F 2009/4557

(57) ABSTRACT

In one set of embodiments, hint metadata for a workload may be provided to a hypervisor, where the hint metadata includes information pertaining to the computational nature, preferences, and/or requirements of the workload (or some portion thereof). This hint metadata may be provided statically prior to VM power-on and/or dynamically during VM runtime. The hypervisor may then schedule the workload on one or more of a plurality of heterogenous processing cores based on the hint metadata.

### BACKGROUND

Unless otherwise indicated, the subject matter described in this section should not be construed as prior art to the claims of the present application and is not admitted as being prior art by inclusion in this section.

Several recent and emerging central processing unit (CPU) architectures employ a hybrid design that combines different types of processing cores (also referred to as simply “cores”) on a single CPU package. For example, Intel® Corporation's Alder Lake architecture includes two core types: high performance but lower efficiency cores, known as performance cores or P-cores, and high efficiency but lower performance cores, known as efficiency cores or E-cores.

Hypervisors are responsible for scheduling a range of workloads in parallel on the processing cores of host systems to maximize CPU utilization and workload performance. However, existing hypervisors do not to take into account the characteristics of the different core types in these recent and emerging hybrid CPU architectures when performing such scheduling. Failing to properly match workloads to core types can lead to inefficient use of CPU resources and performance risks to the workloads.

### BRIEF DESCRIPTION OF THE DRAWINGS

FIG. 1 depicts an example environment.

FIG. 2 depicts an enhanced version of the environment of FIG. 1 that implements the scheduling techniques of the present disclosure according to certain embodiments.

FIG. 3 depicts a static scheduling flowchart according to certain embodiments.

FIG. 4 depicts a dynamic scheduling flowchart according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques that may be implemented by a hypervisor for scheduling workloads such as virtual machines (VMs), containers, and the like on heterogeneous processing cores (i.e., processing cores of different types). As used herein, the phrase “scheduling a workload on a (processing) core” refers to the act of allocating the core for executing some portion of the workload. In the case of a VM, this typically includes assigning a virtual CPU of the VM to run on the allocated core.

At a high level, the techniques of the present disclosure involve providing hint metadata for a workload to the hypervisor, where the hint metadata includes information pertaining to the computational nature, preferences, and/or requirements of the workload (or some portion thereof). This hint metadata may be provided statically prior to VM power-on and/or dynamically during VM runtime. The hypervisor can then schedule the workload on one or more of a plurality of heterogenous processing cores based on the hint metadata. For example, if the plurality of heterogeneous processing cores includes performance and efficiency cores and the hint metadata indicates that the workload is high priority or compute-intensive, the hypervisor may schedule the workload only on performance cores. Conversely, if the hint metadata indicates that the workload is low priority or not compute-intensive, the hypervisor may schedule the workload on efficiency cores to the extent that such cores are available. In this way, the hypervisor can intelligently allocate the heterogenous processing cores as needed to achieve an optimal blend of CPU utilization and workload performance.

### 2. Example Environment and Solution Architecture

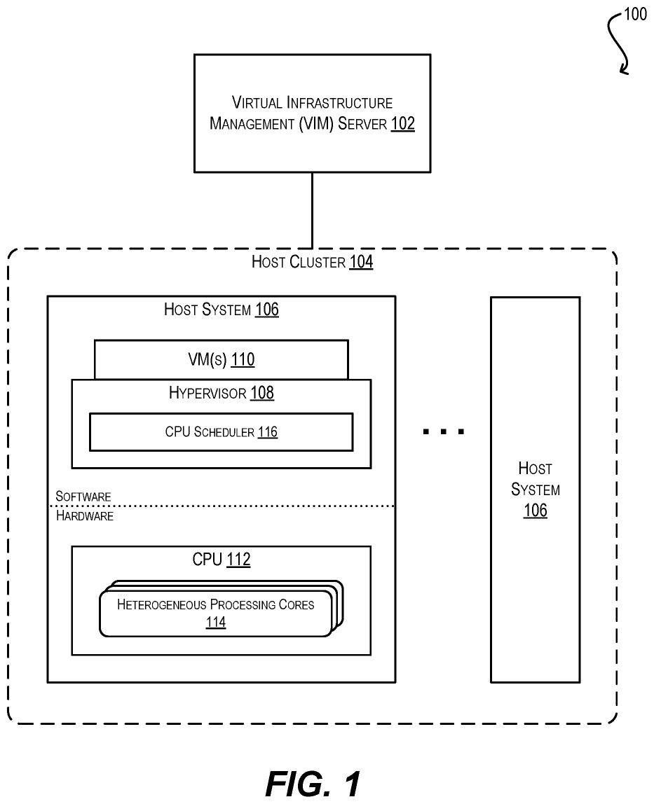

FIG. 1 is a simplified block diagram of an example environment 100 in which certain embodiments of the present disclosure may be implemented. As shown, environment 100 is a virtual infrastructure deployment that comprises a virtual infrastructure management (VIM) server 102 communicatively coupled with a host cluster 104. For example, environment 100 may be a cloud deployment of a public cloud provider or an on-premises deployment of an organization or enterprise.

VIM server 102 is a computer system or group of computer systems that is responsible for provisioning, configuring, and monitoring the entities in host cluster 104. In various embodiments, VIM server 102 may run an instance of VMware's vCenter Server or any other similar virtual infrastructure management software.

Host cluster 104 comprises a plurality of host systems 106, each running in software a hypervisor 108 that provides an execution environment for one or more VMs 110. As known in the art, a VM is a virtual representation of a computer system with its own virtual CPUs, virtual storage, and so on. Each host system 106 also includes in hardware various physical components that are provisioned for use by VM(s) 110 via hypervisor 108. These physical components include, among other things, a CPU 112 (also known as a CPU socket or a CPU package) comprising a plurality of processing cores 114.

For the purposes of this disclosure, it is assumed that processing cores 114 are heterogeneous, which means that they include cores of multiple different types. For example, heterogeneous processing cores 114 can include general-purpose performance cores that provide high performance but lower power efficiency (e.g., P-cores in Intel CPUs and “big cores” in ARM CPUs) and general-purpose efficiency cores that provide high power efficiency but lower performance (e.g., E-cores in Intel CPUs and “LITTLE cores” in ARM CPUs). Alternatively or in addition, heterogeneous processing cores 114 can include core types that are specialized to perform certain tasks, such as artificial intelligence (AI) cores that are designed to accelerate AI and machine learning workloads, cryptoprocessor cores that are designed to accelerate cryptographic operations, and so on.

As mentioned in the Background section, one of the responsibilities of hypervisor 108 is to schedule, via a CPU scheduler 116, the VMs of host system 106 for execution on the host system's processing cores. This generally involves assigning the virtual CPU(s) of each VM to run on one or more of the cores in a time-sliced manner. However, the CPU schedulers of existing hypervisors have no knowledge of the computational needs or preferences of the individual VMs they are tasked with scheduling, and simply make their scheduling decisions based on workload-agnostic metrics such as core load, the total number of VMs/virtual CPUs to be scheduled, and so on. Accordingly, in a scenario like FIG. 1 where the processing cores are heterogeneous, these conventional CPU schedulers cannot assign VMs to specific core types in a manner that best takes advantage of the cores' different characteristics.

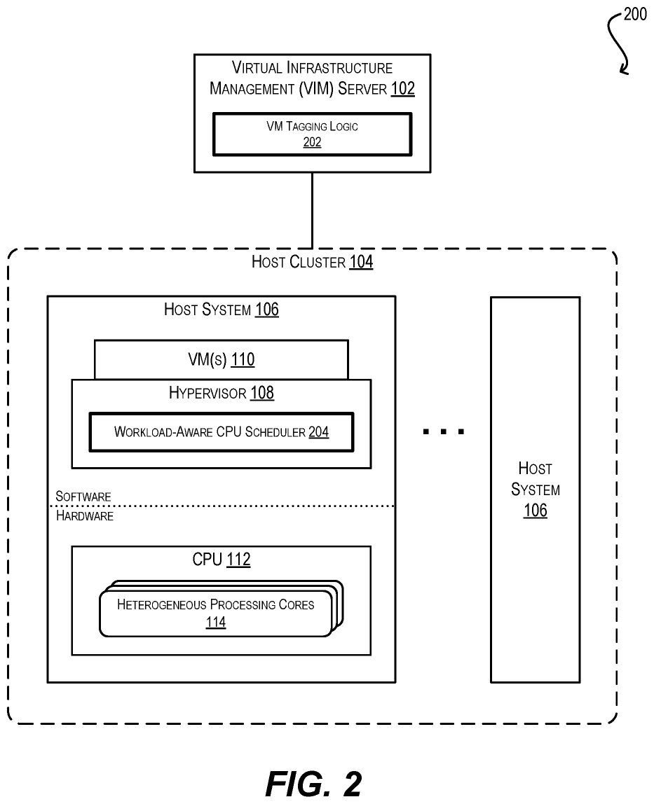

To address this deficiency, FIG. 2 depicts an enhanced version of environment 100 (i.e., environment 200) that includes a novel CPU scheduling framework according to certain embodiments. Among other things, this framework comprises new VM tagging logic 202 within VIM server 102 and a new workload-aware CPU scheduler 204 within hypervisor 108 (which replaces conventional CPU scheduler 116).

Generally speaking, the framework shown in FIG. 2 enables optimal hypervisor scheduling of VMs on the heterogeneous processing cores of host systems 106, based on hint metadata pertaining to the VMs. In one set of embodiments (referred to as the “static scheduling” approach and detailed in section (3) below), VIM server 102 can assign, via VM tagging logic 202, a tag to a VM created/provisioned within host cluster 104 that includes static hint metadata indicating the computational nature, preferences, and/or requirements of the VM as a whole. For instance, the tag may indicate that the VM is high priority/compute-intensive, low priority/not compute-intensive, hybrid priority, an AI workload, etc. One of ordinary skill in the art will recognize that these are merely examples and many other kinds of tags are possible. The tag may be defined by the creator of the VM or some other entity and may be assigned to the VM prior to VM power-on, such as at the time of VM creation.

Then, once the VM is started on a host system 106, workload-aware CPU scheduler 204 of hypervisor 108 can schedule the VM—or more precisely, the VM's virtual CPU(s)—on the host system's heterogeneous processing cores 114 in a manner that is consistent with the static hint metadata included in the VM tag. For example, consider a scenario in which heterogeneous processing cores 114 include a combination of performance cores and efficiency cores. In this scenario, if the tag indicates that the VM is high priority/compute-intensive, workload-aware CPU scheduler 204 may schedule the VM's virtual CPUs solely on performance cores. Further, if the tag indicates that the VM is low priority/not compute-intensive, workload-aware CPU scheduler 204 may schedule as many of the VM's virtual CPUs as possible on efficiency cores, and the remainder on performance cores. Yet further, if the tag indicates that the VM is hybrid priority, workload-aware CPU scheduler 204 may ensure that at least a threshold percentage X of the VM's virtual CPUs are scheduled on performance cores, and the remainder are scheduled on efficiency cores or performance cores based on availability. Threshold X may be user-configurable at the VM, host, or cluster level.

In another set of embodiments (referred to as the “dynamic scheduling” approach and detailed in section (4) below), VIM server 102 can assign, via VM tagging logic 202, a tag to a VM created/provisioned within host cluster 104 which simply indicates that the VM will be dynamically scheduled (e.g., “dynamic” or something similar). VIM server 102 can also assign to the VM a process list comprising a list of guest processes that may be run within the VM and, for each guest process, a corresponding process tag indicating the computational nature, preferences, and/or requirements of that individual guest process (e.g., high priority, low priority, AI, etc.). As with the static scheduling approach, this VM tag and process list may be assigned to the VM prior to power-on, such as during VM creation.

Once the VM is started on a host system 106, hypervisor 108 can identify the presence of the VM's dynamic tag and, in response, can inject a paravirtual guest agent into the VM that maintains a copy of the VM's process list. The guest agent can thereafter monitor for the launching of guest processes within the VM during the VM's runtime and, upon detecting such a process launch, can match the launched process to an entry in the process list, retrieve the corresponding process tag from the matched entry, and provide dynamic hint metadata that includes an identifier (ID) of the virtual CPU to which the launched process is mapped and the retrieved process tag to hypervisor 108.

Finally, workload-aware scheduler 204 of hypervisor 108 can receive the dynamic hint metadata and schedule the identified virtual CPU on one of the host system's heterogenous processing cores 114 in accordance with the received process tag. For example, if the process tag indicates that the launched process is high priority, workload-aware scheduler 204 may schedule the virtual CPU of that process on a performance core. As another example, if the process tag indicates that the launched process is low priority, workload-aware scheduler 204 may schedule the virtual CPU of that process on an efficiency core (if available). As yet another example, if the process tag indicates that the launched process is an AI application, workload-aware scheduler 204 may schedule the virtual CPU of that process on an AI core.

With either of the two approaches described above, hypervisor 108 can intelligently match VMs to different core types in real-time based on the VMs' needs/preferences, thereby leading to an improved balance of CPU utilization and VM performance in comparison to conventional scheduling approaches. It should be appreciated that the foregoing description is illustrative and not intended to limit embodiments of the present disclosure. For example, while this description focuses on the scheduling of VMs, the same principles may be applied for optimally scheduling other types of workloads such as containers.

Further, although the static and dynamic scheduling approaches are presented as separate sets of embodiments, these approaches may be implemented and used together in a single environment/cluster. For example, one subset of VMs in host cluster 104 may be statically scheduled using the static scheduling approach and another subset of VMs in host cluster 104 may be dynamically scheduled using the dynamic scheduling approach. This may be useful in scenarios where some VMs have clearly defined compute needs/preferences while other VMs are less well-defined.

Yet further. although FIG. 2 depicts depict a particular arrangement of framework components in environment 200, other arrangements are possible (e.g., the functionality attributed to a particular component may be split into multiple components, components may be combined, etc.). One of ordinary skill in the art will recognize other variations, modifications, and alternatives.

### 3. Static Scheduling

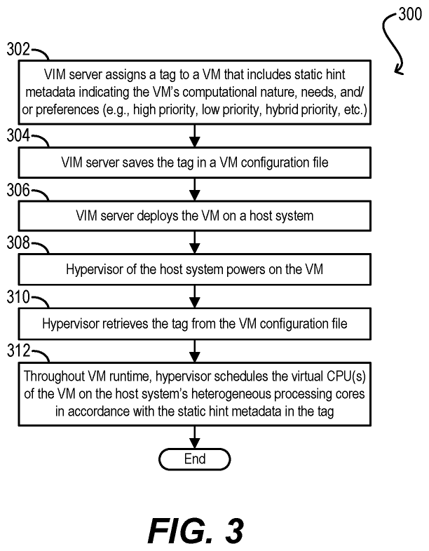

FIG. 3 depicts a flowchart 300 that may be performed VIM server 102 and hypervisor 108 of host system 106 of FIG. 2 (using their respective framework components 202 and 204) for statically scheduling a VM on the host system's heterogeneous processing cores 114 according to certain embodiments.

Starting with step 302, prior to power-on of the VM on host system 106, VIM server 102 can assign a tag to the VM that includes static hint metadata indicating the VM's computational nature, preferences, and/or requirements. As mentioned previously, this tag can be specified by, e.g., the VM's creator and can indicate the type of application(s) that will be run within the VM (e.g., AI applications, crypto applications, etc.), a desired performance level for the VM (e.g., high priority, low, priority, hybrid priority, etc.), or other similar information.

At steps 304 and 306, VIM server 102 can save the tag in a configuration file associated with VM (e.g., a VMX file) and can deploy the VM on host system 106.

At steps 308 and 310, hypervisor 108 of host system 106 can power on the VM and retrieve the tag from the VM configuration file. In some embodiments, hypervisor 108 may retrieve the tag prior to VM power-on.

Finally, throughout the runtime of the VM, hypervisor 108 can schedule the virtual CPU(s) of the VM on the host system's heterogeneous cores 114 in accordance with the static hint metadata in the tag. As noted above, this can include preferentially scheduling high priority VMs on performance cores, low priority VMs on efficiency cores (to the extent possible), hybrid priority VMs on at least a threshold percentage of performance cores, and VMs directed to specific tasks on cores that are specialized for those tasks (e.g., AI, etc.). With respect to performance and efficiency cores, in certain embodiments hypervisor 108 may also support scenarios in which (1) low priority VMs are opportunistically scheduled on performance cores when available, and (2) high priority VM borrow from the pool of efficiency cores when necessary (e.g., when no performance cores are available), pre-empting low priority VMs.

### 4. Dynamic Scheduling

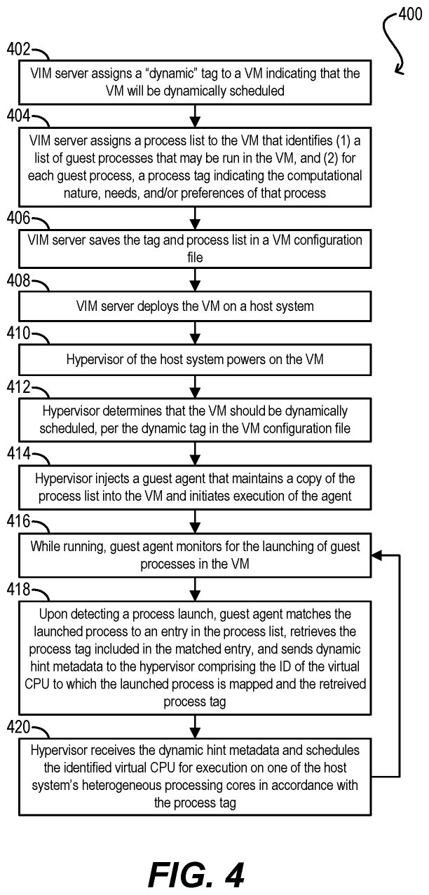

FIG. 4 depicts a flowchart 400 that may be performed VIM server 102 and hypervisor 108 of host system 106 of FIG. 2 (using their respective framework components 202 and 204) for dynamically scheduling a VM on the host system's heterogeneous processing cores 114 according to certain embodiments.

Starting with step 402, prior to power-on of the VM on host system 106, VIM server 102 can assign a tag to the VM which indicates that the VM will be dynamically scheduled (referred to as a dynamic tag). In addition, VIM server 102 can assign a process list to the VM that identifies a list of guest processes that may be run within the VM and, for each process on the list, a process tag that indicates the computational nature, preferences, and/or requirements of that individual process (step 404). In one set of embodiments, these process tags may be similar or identical to the VM tags used in the static scheduling approach. In another set of embodiments, these process tags may include additional information, such a threshold CPU utilization level (explained below). Both the dynamic tag and the process list may be specified by the VM's creator as part of a VM creation/provisioning workflow.

At steps 406 and 408, VIM server 102 can save the tag and the process list in a configuration file associated with the VM (e.g., a VMX file) and can deploy the VM on host system 106.

At steps 410 and 412, hypervisor 108 of host system 106 can power-on the VM and determine that the VM should dynamically scheduled, per the presence of the dynamic tag in the VM's configuration file. In response, hypervisor 108 can inject and initiate execution of a paravirtual guest agent within the VM that maintains a copy of the process list (step 414). In a particular embodiment, hypervisor 108 can perform this step using the VMware Tools platform.

Once the guest agent is running, it can monitor for the launching of guest processes in the VM (step 416). Upon detecting a process launch, the guest agent can match the launched process to an entry in the process list, retrieve the process tag included in the matched entry, and send dynamic hint metadata to hypervisor 108 comprising the ID of the virtual CPU to which the launched process is mapped and the retrieved process tag (step 418). For example, if the launched process is a raylet process for the Ray AI framework that is associated with an “AI” tag in the process list and this raylet process is mapped by the VM's guest OS to virtual CPU 0, the guest agent can send the AI tag and virtual CPU number 0 to hypervisor 108.

Although not shown in the figure, in embodiments where the process tag is associated with a threshold CPU utilization level, the guest agent can delay sending the dynamic hint metadata to the hypervisor 108 until the CPU utilization of the launched process meets or exceeds the threshold level. This is useful for scenarios in which the launched process is not busy at initialization but will ramp up at a later point in time.

At step 420, hypervisor 108 can receive the dynamic hint metadata and schedule the identified virtual CPU for execution on one of the host system's heterogeneous processing cores 114 in accordance with the process tag. For instance, in the example above hypervisor 108 may schedule the VM's virtual CPU 0 on an AI core of the host system. Finally, flowchart 400 can return to step 416 to handle and dynamically schedule additional guest processes launched within the VM, and this can continue until the VM is suspended or powered-off.

### 5. Automated VM Migration to Facilitate Scheduling

In some embodiments, VIM server 102 may implement a mechanism that automatically migrates VMs across host systems 106 of host cluster 104 in order to balance resource usage across the cluster. One example of such a mechanism is VMware Distributed Resource Scheduler (DRS).

In these embodiments, VIM server 102 can leverage this mechanism to facilitate the scheduling of VMs on appropriate core types in accordance with the approaches described above, regardless of the CPU limitations of individual host systems in cluster 104. For example, in one set of embodiments VIM server 102 can monitor for a situation where a VM V placed on a host system H1 of host cluster 104 cannot be scheduled on a particular core type T using either the static or dynamic scheduling approaches, due to a lack of availability of processing cores of type T on H1. For example, VM V may be tagged as high priority but host system H1 may not have any free performance cores for executing V. Upon detecting this situation, VIM server 102 can identify another host system H2 in host cluster 104 that has a sufficient number of available cores of type T for VM V and can automatically migrate V from H1 to H2. In this way, VIM server 102 can ensure that VM V is scheduled on the core type that best matches its needs/preferences, based on the totality of CPU resources available across host cluster 104. This is particular useful for VMs that are scheduled using the dynamic scheduling approach because such a VM may be initially placed on a host system that meets its core type needs, but those needs may change over the course of its runtime as old processes are terminated and new processes are launched.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a hypervisor of a host system, hint metadata for a workload running on the hypervisor, wherein the host system includes a plurality of heterogeneous processing cores, and wherein the hint metadata indicates a computational nature, need, and/or preference of at least a portion of the workload; and
scheduling, by the hypervisor, the workload on one or more of the plurality of heterogeneous processing cores based on the hint metadata.

2. The method of claim 1 wherein the hint metadata was statically assigned to the workload prior to initiation of the workload.

3. The method of claim 1 wherein the hint metadata is dynamically determined while the workload is running.

4. The method of claim 3 wherein the hint metadata is dynamically determined by an agent running within the workload that:
detects a launch of a workload process;
matches the workload process to an entry in a process list;
retrieves a tag for the workload process from the matched entry, wherein the tag indicates a computational nature, need, and/or preference of the workload process;
determines a computational unit of the workload to which the workload process is mapped; and
sends the tag and an identifier of the computational unit to the hypervisor.

5. The method of claim 4 wherein the hypervisor schedules the computational unit for execution on one of the plurality of heterogeneous processing cores based on the tag.

6. The method of claim 1 wherein the plurality of heterogeneous processing cores includes performance cores and efficiency cores, wherein the hint metadata indicates a priority level of the workload, and wherein the workload is scheduled on one or more of the performance cores and/or one or more of the efficiency cores in accordance with the priority level.

7. The method of claim 1 wherein the plurality of heterogeneous processing cores includes specialized processing cores designed to perform a particular task, wherein the hint metadata indicates that the workload is directed to the particular task, and wherein the workload is scheduled on one or more of the specialized processing cores.

8. The method of claim 1 wherein the scheduling fails due to a lack of availability of appropriate processing cores on the host system, and wherein in response to this failure a virtual infrastructure management server migrates the VM to another host system that can accommodate the workload in accordance with the hint metadata.

9. A non-transitory computer readable storage medium having stored thereon program code executable by a hypervisor of a computer system, the program code causing the hypervisor to execute a method comprising:
receiving hint metadata for a workload running on the hypervisor, wherein the computer system includes a plurality of heterogeneous processing cores, and wherein the hint metadata indicates a computational nature, need, and/or preference of at least a portion of the workload; and
scheduling the workload on one or more of the plurality of heterogeneous processing cores based on the hint metadata.

10. The non-transitory computer readable storage medium of claim 9 wherein the hint metadata was statically assigned to the workload prior to initiation of the workload.

11. The non-transitory computer readable storage medium of claim 9 wherein the hint metadata is dynamically determined while the workload is running.

12. The non-transitory computer readable storage medium of claim 11 wherein the hint metadata is dynamically determined by an agent running within the workload that:
detects a launch of a workload process;
matches the workload process to an entry in a process list;
retrieves a tag for the workload process from the matched entry, wherein the tag indicates a computational nature, need, and/or preference of the workload process;
determines a computational unit of the workload to which the workload process is mapped; and
sends the tag and an identifier of the computational unit to the hypervisor.

13. The non-transitory computer readable storage medium of claim 12 wherein the hypervisor schedules the computational unit for execution on one of the plurality of heterogeneous processing cores based on the tag.

14. The non-transitory computer readable storage medium of claim 9 wherein the plurality of heterogeneous processing cores includes performance cores and efficiency cores, wherein the hint metadata indicates a priority level of the workload, and wherein the workload is scheduled on one or more of the performance cores and/or one or more of the efficiency cores in accordance with the priority level.

15. The non-transitory computer readable storage medium of claim 9 wherein the plurality of heterogeneous processing cores includes specialized processing cores designed to perform a particular task, wherein the hint metadata indicates that the workload is directed to the particular task, and wherein the workload is scheduled on one or more of the specialized processing cores.

16. The non-transitory computer readable storage medium of claim 9 wherein the scheduling fails due to a lack of availability of appropriate processing cores on the host system, and wherein in response to this failure a virtual infrastructure management server migrates the VM to another host system that can accommodate the workload in accordance with the hint metadata.

17. A computer system comprising:
a plurality of heterogeneous processing cores;
a hypervisor; and
a non-transitory computer readable medium having stored thereon program code that, when executed, causes the hypervisor to:
receive hint metadata for a workload running on the hypervisor, wherein the hint metadata indicates a computational nature, need, and/or preference of at least a portion of the workload; and
schedule the workload on one or more of the plurality of heterogeneous processing cores based on the hint metadata.

18. The computer system of claim 17 wherein the hint metadata was statically assigned to the workload prior to initiation of the workload.

19. The computer system of claim 17 wherein the hint metadata is dynamically determined while the workload is running.

20. The computer system of claim 18 wherein the hint metadata is dynamically determined by an agent running within the workload that:
detects a launch of a workload process;
matches the workload process to an entry in a process list;
retrieves a tag for the workload process from the matched entry, wherein the tag indicates a computational nature, need, and/or preference of the workload process;
determines a computational unit of the workload to which the workload process is mapped; and
sends the tag and an identifier of the computational unit to the hypervisor.

21. The computer system of claim 19 wherein the hypervisor schedules the computational unit for execution on one of the plurality of heterogeneous processing cores based on the tag.

22. The computer system of claim 17 wherein the plurality of heterogeneous processing cores includes performance cores and efficiency cores, wherein the hint metadata indicates a priority level of the workload, and wherein the workload is scheduled on one or more of the performance cores and/or one or more of the efficiency cores in accordance with the priority level.

23. The computer system of claim 17 wherein the plurality of heterogeneous processing cores includes specialized processing cores designed to perform a particular task, wherein the hint metadata indicates that the workload is directed to the particular task, and wherein the workload is scheduled on one or more of the specialized processing cores.

24. The computer system of claim 17 wherein the scheduling fails due to a lack of availability of appropriate processing cores on the host system, and wherein in response to this failure a virtual infrastructure management server migrates the VM to another host system that can accommodate the workload in accordance with the hint metadata.
